(19) United States
(12) Patent Application Publication
(10) Pub. No.: US 2016/0162240 A1
(43) Pub. Date: Jun. 9, 2016

(54) METHOD AND APPARATUS FOR CONSTRUCTING MULTI-SCREEN DISPLAY

(71) Applicant: SAMSUNG ELECTRONICS CO., LTD., Gyeonggi-do (KR)

(72) Inventors: Boncheol Gu, Gyeonggi-do (KR); Junghun Kim, Gyeonggi-do (KR)

(21) Appl. No.: 14/909,013

(22) PCT Filed: Jul. 29, 2014
(86) PCT No.: PCT/KR2014/006923

§ 371 Date: Jan. 29, 2016

(30) Foreign Application Priority Data
Jul. 29, 2013 (KR) 10-2013-0089375

(51) Int. Cl. G06F 3/14; H04W 60/00; H04W 4/00

(52) U.S. Cl. CPC G06F 3/1423; H04W 4/008; H04W 60/00; H04W 88/02

(57) ABSTRACT

Disclosed herein are a method an electronic device for constructing a multi-screen display. A plurality of client devices are registered to be included in the multi-screen display and an image is split. Portions of the split image are distributed among the registered devices.

### TECHNICAL FIELD

The present disclosure relates generally to a method of constructing a multi-screen display and an electronic device supporting the same, and more particularly to, a method and an apparatus for constructing a multi-screen display by using an NFC module and various sensors included in an electronic device.

### BACKGROUND ART

In general, multi-screen may refers to an image scheme that splits an image into a plurality of image portions and outputs each portion on a respective display. That is, the multi-screen may be a system that can display one image through a combination of display screens. The multi-screen can output one enlarged or reduced image on a screen and simultaneously output image signals on a plurality of display screens.

### DISCLOSURE OF INVENTION

### Technical Problem

Conventional multi-screen displays may connect different mobile communication terminals via a physical medium, such as a separate Universal Serial Bus (USB) cable or a connection terminal. Unfortunately, these physical connections used in conventional multi-screen methods are cumbersome. This is especially true when a number of portable terminals included in the multi-screen display increases. Inconvenient errors may occur in constructing the multi-screen across the terminals.

### Solution to Problem

In accordance with an aspect of the present disclosure, a method of constructing a multi-screen display using one or more electronic devices is provided. The method may include: executing a multi-screen display mode; registering a plurality of client devices to be included in the multi-screen display; splitting an image into a plurality of image portions; and distributing the plurality of image portions among the plurality of client devices.

In accordance with an aspect of the present disclosure, an electronic device supporting a construction of a multi-screen display is provided. The electronic device may include: a processor to: receive, using a communication unit, status information and attribute information from a plurality of client devices;
identifying coordinates of the client devices relative to those of the electronic device using the status information and the attribute information of the client devices; and
split an image into a plurality of image portions; and distribute the plurality of image portions among the plurality of client devices using the coordinates.

Thus, the techniques disclosed herein may easily and rapidly manage a plurality of multi-screen displays by identifying relative coordinates of a plurality of electronic devices. Furthermore each electronic device used in the multi-screen display may be classified based on relative coordinates and used for a unique purpose in the multi-screen display.

In another example, through the use of at least one of a camera, a sensor, an NFC module, and a communication module installed in an electronic device, efficiency of the multi-screen display may be enhanced, since a separate device for connecting the devices is not needed.

In a further example, positions of a neighboring device or adjacent device can be detected using a sensor such as an installed camera, so that additional electronic devices can be seamlessly included in the multi-screen display scheme.

### Advantageous Effects of Invention

In view of the above, aspects of the present disclosure provide a method of constructing a multi-screen display such that a plurality of electronic devices included in the multi-screen display are rapidly managed and controlled. Some of the plurality of electronic devices may be configured as the multi-screen display, while other electronic devices may serve different roles. This allows the number of electronic devices included in the multi-screen display to be increased seamlessly.

### BRIEF DESCRIPTION OF DRAWINGS

The above and other objects, features and advantages of the present disclosure will be more apparent from the following detailed description in conjunction with the accompanying drawings, in which:

FIG. 1 illustrates an example of a multi-screen display in accordance with aspects of the present disclosure;

FIG. 2 is a block diagram of an example electronic device included in a multi-screen display in accordance with aspects of the present disclosure;

FIG. 3 illustrates is an example method in accordance with aspects of the present disclosure;

FIG. 4 is a signal flow diagram illustrating an example multi-screen display method in accordance with aspects of the present disclosure;

FIG. 5 illustrates an example of an execution screen displayed on a main device in accordance with aspects of the present disclosure;

FIGS. 6 to 9 illustrate working examples of a multi-screen display in accordance with aspects of the present disclosure;

FIG. 10 illustrates another working example of a multi-screen display in accordance with aspects of the present disclosure; and

FIG. 11 is a further working example in accordance with aspects of the present disclosure.

### MODE FOR THE INVENTION

A method and an apparatus disclosed herein may be applied to an electronic device having a Near Field Communication (NFC) module. For example, the electronic device may be a smart phone, a tablet Personal Computer (PC), a notebook PC or the like. The electronic device detects adjacent electronic devices through the NFC module.

Hereinafter, the method and the apparatus of the present disclosure will be described in detail. In the following description, a detailed description of known functions and configurations incorporated herein will be omitted when it is determined that the detailed description thereof may unnecessarily obscure the subject matter of the present disclosure. Terms or words used below should not be interpreted using typical or dictionary limited meanings, and should be construed as meanings and concepts conforming to the technical spirit of the present disclosure. Thus, it should be understood that there may be various equivalents and modifications that can be substituted for the examples disclosed herein at a time of filing this application. Furthermore, in the accompanying drawings, some structural elements may be exaggeratingly or schematically shown, or will be omitted.

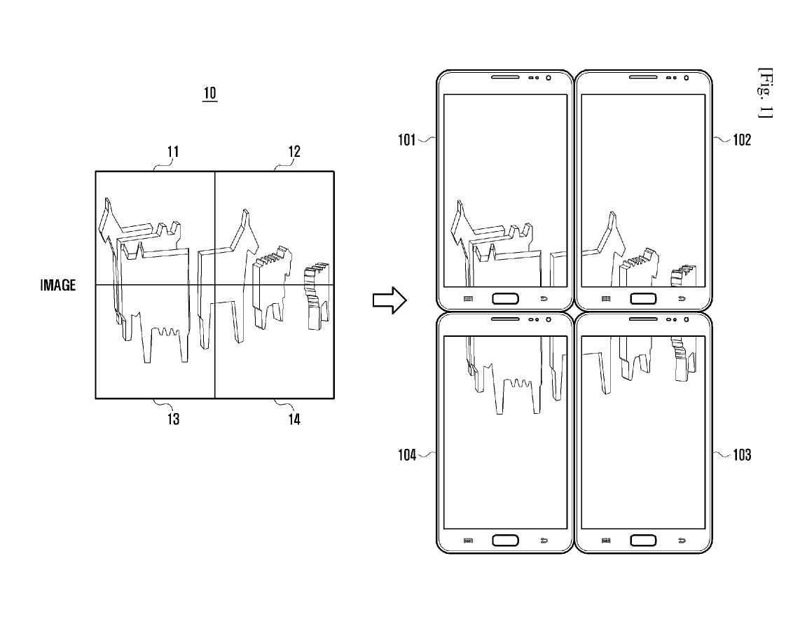

FIG. 1 illustrates an example of a multi-screen display in accordance with aspects of the present disclosure. Referring to FIG. 1, one image 10 is split and output on a plurality of electronic devices 101 to 104 through a multi-screen display.

The electronic device 101 may include an NFC module, a communication module, and various sensors, and at least one of the NFC module, the communication module, and the various sensors may be configured as the main device 101. The remaining devices may be configured as client devices 102, 103, and 104. The main device 101 may serve as a server of the multi-screen display and the client devices 102 to 104 may serve as clients corresponding to the server. That is, the main device 101 is connected to the client devices 102 to 104 for communication, receives status information and attribute information of the client devices 102 to 104 through the connection, and controls the client devices 102 to 104 based on the received status information and attribute information, so as to construct the multi-screen display. For example, the main device 101 may split an image into a plurality of images in accordance with a layout in which the client devices 102 to 104 are arranged, a number of client devices, and a resolution of each of the client devices. Main device 101 may transmit each portion of the image to a device corresponding to each portion.

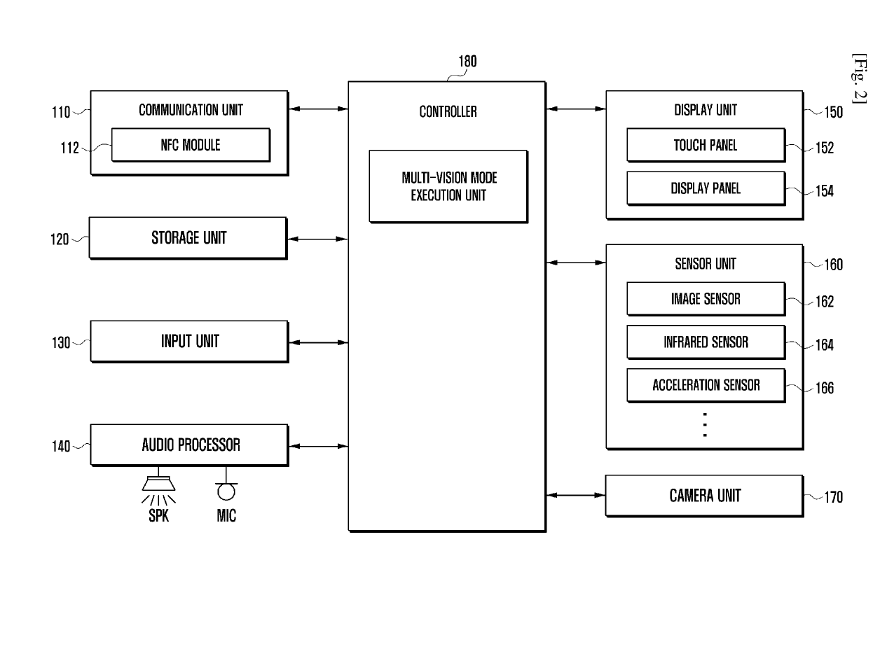

The method of constructing the multi-screen display and the apparatus supporting will be described below in detail with reference to FIGS. 2 to 11.

FIG. 2 is a block diagram of an example electronic device included in a multi-screen display. The example electronic device may include a communication unit 110, a storage unit 120, an input unit 130, an audio processor 140, a display unit 150, a sensor unit 160, a camera unit 170, and a controller 180.

The communication unit 110 may include one or more modules which enable wireless communication between a user device and a wireless communication system or between a user device and another user device. The communication unit 110 of the present disclosure may be prepared for wireless communication between the main device 101 and the client devices 102 to 104. For example, communication unit 110 may include a mobile communication module, a Wireless Local Area Network (WLAN) module, a short-range communication module, a location calculation module, a broadcast receiving module and the like.

The mobile communication module transmits/receives wireless signals to/from at least one of a base station, an external terminal and a server over a mobile communication network. The wireless signal may include a voice call signal, a video call signal, or various types of data in accordance with text/multimedia message transmission/reception.

The mobile communication module may access a service provider server, a content server or the like, and download content, such as an image file, a moving image file, a sound source file and the like, in a file form. For example, the mobile communication module disclosed herein may receive an image to be output on the multi-screen display.

The WLAN module is a module for accessing an Internet and establishing a WLAN link between the electronic device and another user device. The WLAN module may be mounted inside or outside the electronic device. Use may be made of Wireless Internet technologies, such as WLAN (Wi-Fi), Wireless broadband (Wibro), World Interoperability for Microwave Access (Wimax), High Speed Downlink Packet Access (HSDPA), and the like.

The short-range communication module refers to a module used for short-range communication. Use may be made of short-range communication technologies, such as Bluetooth, Radio Frequency Identification (RFID), Infrared Data Association (IrDA), Ultra WideBand (UWB), ZigBee, Near Field Communication (NFC) and the like. When the electronic device is connected to another electronic device through short-range communication, the short-range communication module may transmit/receive content including metadata and the like to/from another electronic device.

The storage unit 120 is a secondary memory unit and may include a storage medium of at least one type from among a flash memory type, a hard disk type, a multimedia card micro type, a memory card type (e.g., a Secure Digital (SD) or eXtreme Digital (XD) memory card), a Random Access Memory (RAM), a Static RAM (SRAM), a Read Only Memory (ROM), a Programmable ROM (PROM), an Electrically Erasable PROM (EEPROM), a Magnetic RAM (MRAM), a magnetic disk, an optical disk, and the like. The electronic device may also operate in relation to a web storage which performs a storage function of the storage unit 120 on the Internet.

The storage unit 120 may store data (for example, a recording file) generated in a portable terminal or data (for example, a music file, a video file and the like) received through the communication unit 110 under a control of the controller 180. The storage unit 120 stores an Operating System (OS) for operating the portable terminal and various programs.

For example, the storage unit 120 stores an application program for constructing the multi-screen display. The application program for constructing the multi-screen display may include a program which executes the electronic device in a multi-screen mode, and the multi-screen mode has a selection option for executing the electronic device as the main device or the client device. The application program may further include a function which executes at least one device of the NFC module, the communication module, and the various sensors. Furthermore, data generated in accordance with an execution of the multi-screen mode may be stored in the storage unit 120.

The storage unit 120 may include an embedded application and a 3rd party application. In one example, the embedded application may be an application basically installed in the portable terminal. For example, the embedded application may include an environment setting program, a browser, an email, an instant messenger and the like. In another example, the 3rd party application may be an application downloaded from an online market and then installed in the portable terminal and has various types. The 3rd party application is freely installed and removed. When the portable terminal becomes larger, a booting program is first loaded to a main memory unit (for example, RAM) of the controller 180. The booting program loads an operating system to the main memory unit to allow the portable terminal to operate. The operating system loads various programs to the main memory unit and executes the loaded programs. For example, when contact with an external device is detected, the operating system loads a data communication program to the main memory unit and executes the loaded data communication program.

The input unit 130 generates input data for controlling an execution of the electronic device by a user. The input unit 130 may include a keypad, a dome switch, a touch pad (resistive type/capacitive type), a jog wheel, a jog switch and the like. The input unit 130 may be implemented in the form of buttons on an outer surface of the electronic device, and some buttons may be implemented by a touch panel. For example, the input unit 130 may be an input device through which the main device 101 inputs a command for controlling executions of the client devices 102 to 104 in the multi-screen mode. Further, each of the client devices 102 to 104 may have an input device through which the user directly inputs an execution command.

The audio processor 140 delivers an audio signal, which has been received from the controller 180, to a speaker (SPK), and delivers an audio signal such as voice and the like, which has been received from a microphone (MIC), to the controller 180. The audio processor 140 may convert sound data such as a voice/sound into an audible sound and output the audible sound through the SPK. The audio processor 140 may convert an audio signal, such as a voice and the like, which has been received from the MIC, into a digital signal, and deliver the digital signal to the controller 180.

The SPK may output audio data received from communication unit 110, audio data received from the MIC, or audio data stored in the storage unit 120, in a call mode, a recording mode, a voice recognition mode, a broadcast reception mode, a photographing mode, a situation recognition service execution mode and the like. The SPK may output a sound signal related to a function (for example, feedback of situation information in accordance with an action execution, call connection reception, call connection transmission, photographing, media content (music file or dynamic image file) reproduction and the like) performed in the electronic device.

For example, the SPK may be a sound output device for outputting a sound signal transmitted together with a multi-screen image signal. In one example, a speaker included in the client device 102, 103, or 104 selected by the main device 101 may be turned on, and such a sound outputting method may be configured by a designer in advance or changed by a user after the electronic device is released.

The MIC receives an external sound signal in the call mode, the recording mode, the voice recognition mode, the photographing mode, a voice recognition-based dictation execution mode and the like and processes the external sound signal into electrical voice data. In the communication mode, the processed voice data may be converted into a form which can be transmitted to a mobile communication base station through the mobile communication module and then output. Various noise removal algorithms for removing noise generated during a process of receiving an external sound signal may be implemented in the MIC.

The display unit 150 may be implemented by, for example, a touch screen which performs functions of the input unit and the display unit for an interaction with the user. That is, the display unit 150 includes a touch panel 152 and a display panel 154. The touch panel 152 may be placed on the display panel 154. The touch panel 152 generates an analog signal in response to a user gesture on the touch panel 152, converts the analog signal into a digital signal, and transmits the digital signal to the controller 180. The controller 180 detects a user's gesture from a received touch event. The user's gesture may be divided into a touch and touch gesture. Furthermore, the touch gesture may include a tap, a drag, a flick and the like. In one example, the term “touch” may refer to a state of contacting the touch screen, and the term “touch gesture” may refer to a motion of a touch from a touch on the touch screen (touch-on) to the removal of the touch from the touch screen (touch-off). The touch panel 152 may be a complex touch panel including a hand touch panel detecting a hand gesture and a pen touch panel detecting a pen gesture. Here, the hand touch panel may be embodied in a capacitive type. The hand touch panel may be implemented in a resistive type, an infrared type or an ultrasonic type. Further, the hand touch panel may generate a touch event not only by a user's hand gesture, but also by another subject (for example, a subject made of a conductive material capable of causing a variation of capacitance). The pen touch panel may be implemented in an electromagnetic induction type. Accordingly, the pen touch panel may generate a touch event by a touch stylus pen especially made to form a magnetic field. Under a control of the controller 180, the display panel 154 may convert image data, which has been received from the controller 180, into an analog signal, and may display the converted analog signal. That is, the display panel 154 may display various screens in accordance with the use of the portable terminal, for example, a lock screen, a home screen, an application (App), an execution screen, a keypad and the like. The display panel 154 may be formed by a Liquid Crystal Display (LCD), an Organic Light Emitting Diode (OLED), or an Active Matrix Organic Light Emitted Diode (AMOLED).

In one example, the display unit 150 may output split images received in the multi-screen display mode. Alternatively, when the electronic device 100 is configured in a remote control mode of the multi-screen display, the display unit 150 may output a screen corresponding to the remote control, for example, a screen including soft input keys, such as a number key, a character key, a shortcut key and the like for the remote control. Further, when the electronic device 100 is configured as a device for a channel preview, the display unit 150 may output a screen image corresponding to the channel preview.

The sensor unit 160 is a sensor included in the electronic device 100. In another example, the sensor unit 160 may measure a physical change generated in a body thereof and a physical change of another device 100 adjacent to the electronic device 100.

The sensor unit 160 may include at least one of an image sensor, an infrared sensor, an acceleration sensor, a gyroscope sensor, a geo-magnetic sensor, a gravity sensor, and a tilt sensor. In addition, the sensor unit 160 may include at least one of a motion sensor, a temperature sensor, a proximity sensor, and an environmental sensor and any sensor can be accepted if the sensor can detect a physical change of another electronic device within a detectable range of electronic device 100.

The camera unit 170 may be a camera device arranged at each of a front surface and a back surface of a body of the electronic device 100. In a further example, the camera unit 170 may include at least one device that detects an electronic device within a detectable range and obtains an image of the electronic device. When the obtained image is transmitted to the controller 180, the controller 180 may detect a number of electronic devices within detectable range; an arrangement of the electronic devices within the detectable range; and a movement based on the obtained image.

The controller 180 controls an overall operation of the electronic device and a signal flow between the internal components of the electronic device; performs a function of processing data; and controls the supply of power from a battery to the components of the electronic device. The controller 180 may include a main memory unit which stores an application program and an operating system, a cache memory which temporarily stores data to be written in the storage unit 120 and temporarily stores data read from the storage unit 120, a Central Processing Unit (CPU), a Graphics Processing Unit (GPU) and the like. The operating system manages computer resources such as a CPU, a GPU, a main memory unit, a secondary memory unit and the like while serving as an interface between hardware and a program.

That is, the operating system operates the electronic device, determines the order of tasks, and controls a CPU calculation and a GPU calculation. Further, the operating system performs a function of controlling an execution of an application program and a function of managing the storage of data and files.

The CPU is a core control unit of a computer system for calculating and comparing data and analyzing and executing instructions. In place of the CPU, the GPU is a graphic control unit which performs calculations and comparisons of graphic-related data, and the interpretation and execution of instructions, and the like. Each of the CPU and the GPU may be integrated into one package in which two or more independent cores (for example, quad-core) are implemented by a single integrated circuit. The CPU and the GPU may be a System on Chip (SoC). Alternatively, the CPU and the GPU may be packaged in a multi-layer. Meanwhile, a component including the CPU and the GPU may be referred to as an “Application Processor (AP).”

Controller 180 may control various signal flows, information collection and information output to execute the multi-screen display mode in accordance with aspects of the present disclosure. When power is supplied, the controller 180 controls each of the components of the electronic device 100 to be initialized by using the supplied power. When the initialization is completed, the controller 180 may identify the multi-screen display mode and also identify whether a current mode is the multi-screen display mode.

The multi-screen display mode may be a mode in which a user outputs images split from one image on a plurality of electronic devices arranged or stacked in a desired form. That is, the multi-screen mode may be a mode in which a multi-screen display is constructed by a plurality of electronic devices. Each of the electronic devices included in the multi-screen display may comprise an application program executing the multi-screen mode, and the multi-screen mode may be automatically executed by a designer or selectively executed by a switch, an input key, or the like, manually in accordance with a user's option.

Further, the controller 180 may operate the electronic device 100 as a main device 101 or a client device 102, 103, or 104. The main device 101 may be configured as a device serving as a main server that controls the client devices to construct the multi-screen display. The main device 101 may operate the NFC module as a reader and execute the communication module 112 and the sensor unit 160 in accordance with the execution of the multi-screen display mode. As the NFC module operates as the reader, the main device 101 may detect contact with the client device having the NFC module or may detect that the client device is within a detectable range using sensor unit 160. NFC is a data communication technique based on ISO/IEC18092 (NFCIP-1) in a Peer-to-Peer (P2P) manner. When two electronic devices contact each other (for example, when an interval between the two devices is equal to or smaller than 4 cm), the two devices may exchange messages by using the NFC module. Accordingly, the main device 101 may detect the client devices.

The main device 101 may detect and register the client devices 102 to 104 as electronic devices for use in the multi-screen display. Since the main device 101 is configured as a server of the multi-screen display, the main device 101 may add detected devices as the client devices. At this time, the main device 101 may distinguish different client devices by assigning inherent IDs to the detected client devices.

The main device 101 may be connected to communicate with the client devices 102 to 104 through the communication module. In one example, the main device 101 may induce a connection through a WiFi module installed in the client devices 102 to 104 based on information of the client devices 102 to 104 connected to the main device 101 through the NFC module. The present disclosure describes a WiFi module as the communication module, but at least one of a Bluetooth module, a ZigBee module and a wireless network optimized for an inherent protocol may be used.

The client devices 102 to 104 may execute the multi-screen mode after a communication connection with the main device 101 is made, and may operate at least one of the various sensors and the NFC module in the multi-screen mode.

The client devices 102 to 104 obtain status information of each other, such as arrangement positions of each client device with respect to the main device 101 and movement speeds of each client device with respect to main device 101, and attribute information of each electronic device. The attribute information of the electronic devices may include information, such as a type, a model, a display size, and a display resolution of the electronic device.

The client devices 102 to 104 may transmit the obtained status information and attribute information of the electronic devices to the main device 101 through the communication module. By way of example, one client device 102 may detect an approach or contact of other client devices 103 and 104 through at least one of the NFC module and the various sensor units. Thereafter, the client device 102 may obtain status information and attribute information of the client devices 103 and 104 through connections of communication modules of the client devices 103 and 104 and transmit the obtained status information and attribute information to the main device 101.

Having received the status information and attribute information of the client device 104 from the client device 102, the main device 101 may be connected to communicate with the client device 104. For example, the main device 101 may induce a connection through the communication module installed in the client device 102 based on the received information of the client device 102. The present disclosure may use at least one of a WiFi module, a Bluetooth module, a ZigBee module and a wireless network optimized for a protocol used by the communication module. Although the present disclosure has described the first client device 102 and the second client device 104 as the client devices, the present disclosure is not limited thereto and may further add N client devices.

The main device 101 identifies an arrangement of screens for the multi-screen display based on the status information and the attribute information of the client devices 102 to 104 and distributes a multi-screen image among the client devices 102 to 104 accordingly. The main device 101 may construct the multi-screen display based on at least one of inherent IDs assigned to the client devices, a total number of client devices, a layout of the client devices, and sizes of the client devices. Furthermore, the main device 101 may classify each device included in the multi-screen display as having a specific or unique role in the multi-screen display arrangement and may configure each device to perform its role.

Thereafter, the main device 101 transmits a portion of an image to each of the client devices 102 to 104 accordingly. The multi-screen image may be image data stored in the main device 101 or image data received from an external device or an external network. Each of the client devices 102 to 104 output the received portion of the image data. In addition, the main device 101 may also output a portion of the image data.

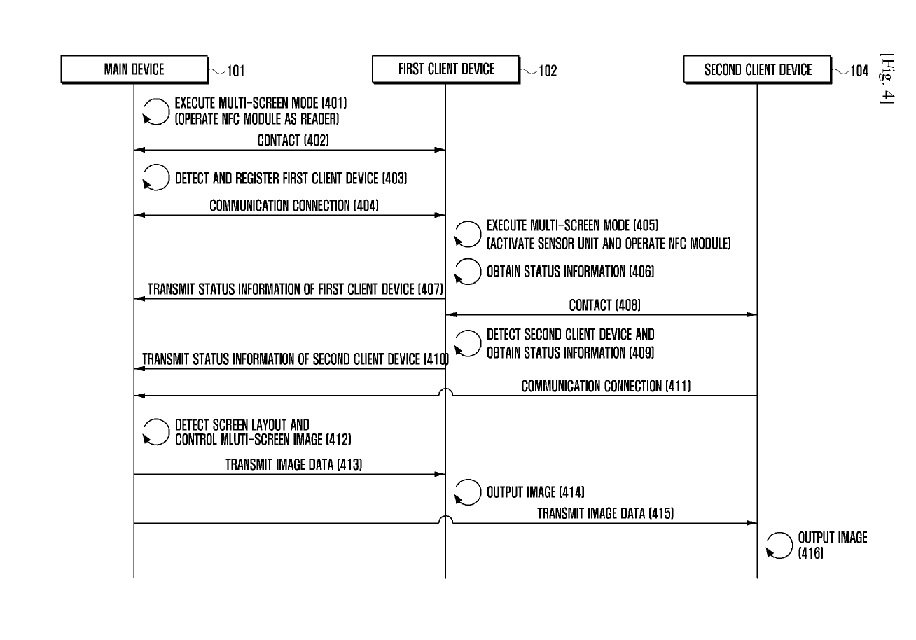

FIG. 3 illustrates an example method in accordance with aspects of the present disclosure. A main device is configured in accordance with an execution of a multi-screen display mode in operation 310. That is, at least one of a plurality of electronic devices to be included in the multi-screen display may be configured as the main device which serves as a server. Such a configuration may be selected in accordance with a user's option or automatically made by a designer in a manufacturing process. Referring to FIG. 5, an example of a screen displayed on the electronic device 100 for configuring the multi-screen display mode is shown. The screen may display an icon for selecting an execution of a WiFi module, an icon for toggling the multi-screen display mode on/off, and an icon for selecting an execution of the sensor unit.

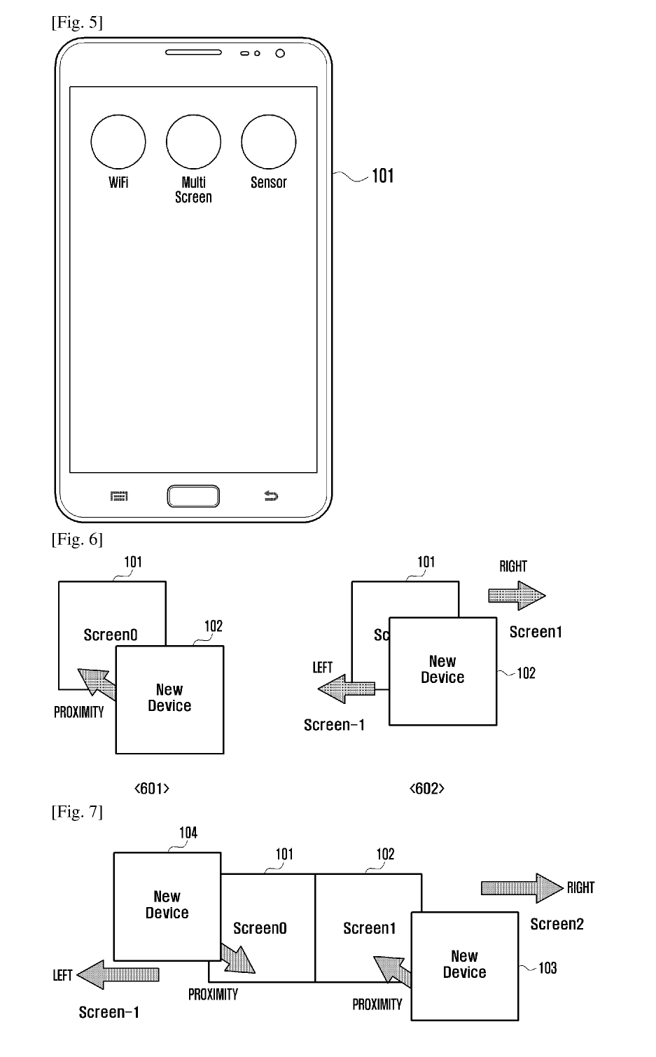

Next, the main device detects a client device and additionally registers the detected client device in operation 320. For example, the main device 101 may detect the client device by detecting a contact of the client device 102 through the NFC module as illustrated in FIG. 6. At this time, the main device may obtain at least one of a movement direction, a movement speed, and an arrangement position of the client device, and a relative coordinate of the client device 102 relative to the main device 101 through the sensor installed in the main device 101.

Further, the main device may assign an inherent ID to each of the detected client devices and generate relative coordinate information of the client devices relative to the main device.

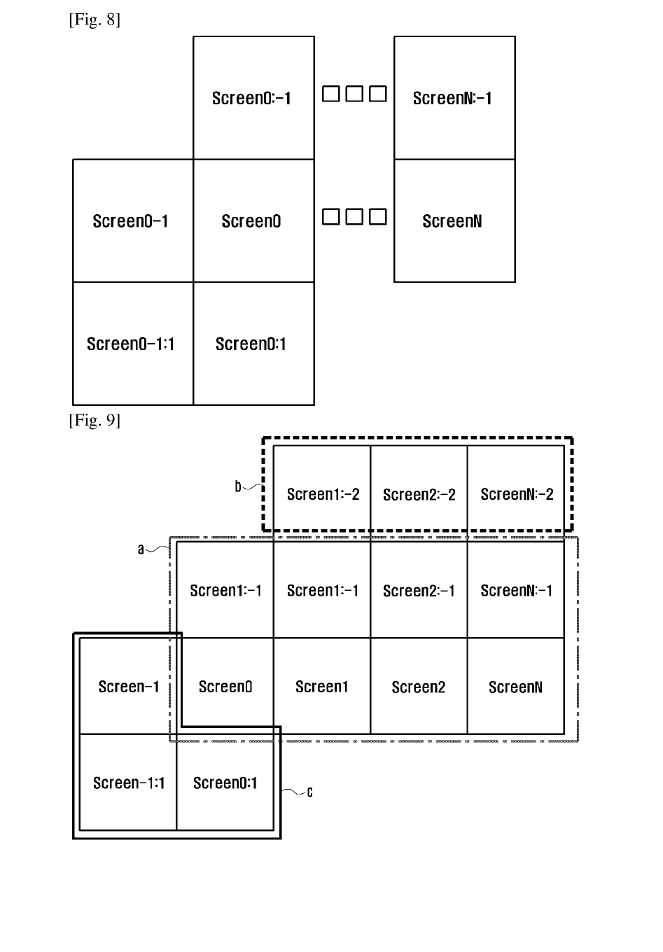

For example, as illustrated in FIG. 8, the client devices may be additionally expanded. The main device may configure its own coordinate as “0” and configure relative coordinates of the remaining client devices as “−1, −1:1, 0:1, 0:−1, N:−1” relative to the coordinates of the main device.

Meanwhile, a plurality of client devices included in the multi-screen display may be directly detected by the main device 101. However, when a number of client devices arranged to construct the multi-screen display increases as illustrated in FIG. 8, the client devices may be outside the detectable range of the main device (screen 0), that is, the client devices are located within a range in which the NFC module or the various sensors cannot detect the client devices.

In this instance, the first client device 102, which was first to connect with main device 101, may detect the second client device 103 located within an area in which the main device 101 cannot detect the second client device 103 as illustrated in FIG. 7. At this time, the main device 101 may indirectly transmit/receive data to/from the second client device 103 through the first client device 102 or directly transmit/receive data to/from the second client device 103 through a communication connection in some cases.

Referring back to FIG. 3, the main device may establish the multi-screen display through the main screen and the registered client devices in operation 330. That is, the main device detects arrangement statuses of the client devices based on coordinate information of the client devices relative to the coordinates of the main device and may configure the multi-screen display based on the arrangement statuses. For example, when a layout of arranged devices is configured as illustrated in FIG. 9, the main device may configure the devices arranged in section a for the multi-screen display and configure the remaining devices as devices playing other roles.

Referring back to FIG. 3, the main device may split one image and output the portion of the images on the configured multi-screen display in operation 340.

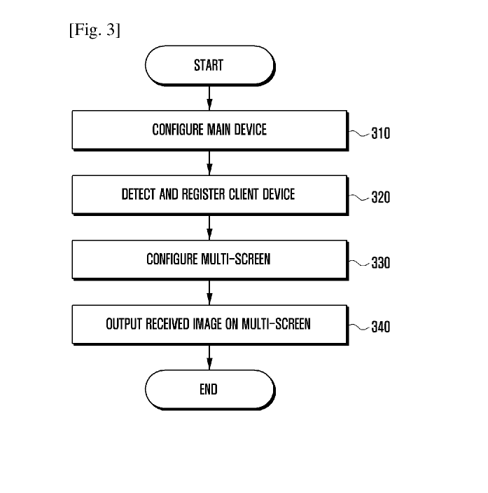

FIG. 4 is a signal flow diagram illustrating an example multi-screen display method in accordance with aspects of the present disclosure. The main device 101 executes the multi-screen mode in operation 401. The multi vision mode may be a mode in which a user outputs portions of images split from one image on a plurality of electronic devices arranged or stacked in a desired form. That is, the multi-screen mode may be a mode in which a multi-screen display is constructed by a plurality of electronic devices. Each of the electronic devices included in the multi-screen display may comprise an application program executing the multi-screen mode, and the multi-screen mode may be automatically executed by a designer or selectively executed by a user. The main device 101 may include an application program executing the multi-screen mode which may be configured as a device serving as a main server for constructing the multi-screen display.

The main device 101 may operate the NFC module as a reader and execute the communication module and the sensor unit in accordance with an execution of the multi-screen mode. As the NFC module operates as the reader, the main device 101 may detect another electronic device having the NFC module. Referring back to FIG. 4, the main device 101 may detect the first client device 102 using the NFC module.

AS noted above, NFC is a data communication technique based on ISO/IEC18092 (NFCIP-1) in a Peer-to-Peer (P2P) manner. When two electronic devices are within a certain detectable range of each other (for example, when an interval between the two devices is equal to or smaller than 4 cm), the two devices may exchange messages by using the NFC module. Accordingly, the main device 101 may detect the first client device 102.

Next, the main device 101 may detect and register the first client device 102 as an electronic device included in the multi-screen display in operation 403. Since the main device 101 is first configured as a server of the multi-screen display, the main device 101 may add detected devices as the client devices. At this time, the main device 101 may distinguish different client devices by assigning inherent IDs to the detected client devices.

The main device 101 may be connected to communicate with the first client device 102 through the communication module in operation 404. Specifically, the main device 101 may induce a connection through a WiFi module installed in the first client device 102 based on information of the first client device 102 connected to the main device 101 through the NFC module. The present disclosure describes a WiFi module as the communication module, but other protocols, such as a Bluetooth module, or a ZigBee module may be used.

The first client device 102 executes the multi-screen mode in operation 405 after communication with the main device 101 is made. In the multi-screen mode, at least one of the various sensors and the NFC module may be executed. The first client device 102 may obtain status information, such as an arrangement position of the first client device 102 relative to the main device 101 and a movement speed of the first client device 102 from the main device 101, and attribute information of the first client device. The attribute information of the electronic device may include information, such as a type, a model, a display size, and a display resolution of the electronic device.

The first client device 102 transmits the obtained status information and attribute information of the electronic device to the main device 101 through the communication module in operation 407.

Meanwhile, the first client device 102 may detect an approach or contact of the second client device 104 through at least one of the NFC module and the various sensor units in operation 408. The first client device 102 may obtain status information and attribute information of the second client device 104 through a connection with the communication module of the second client device 104 in operation 409 and transmit the obtained status information and attribute information to the main device in operation 410.

The main device 101 having received the status information and attribute information of the second client device 104 from the first client device 102 may be connected to communicate with the second client device 104 in operation 411. For example, the main device 101 may induce a connection through the communication module installed in the second client device 104 based on the received information of the second client device 104. The present disclosure may use at least one of a WiFi module, a Bluetooth module, or a ZigBee module. Although the present disclosure has described the first client device 102 and the second client device 104 as the client devices, the present disclosure is not limited thereto and may further add N client devices.

The main device 101 identifies an arrangement of screen portions for a multi-screen display based on the status information and the attribute information and controls a portions of an image to be output on the multi-screen display in operation 412. The main device 101 may construct the multi-screen display based on at least one of inherent IDs assigned to the client devices, a total number of client devices, a layout of the client devices, and sizes of the client devices. Further, the main device 101 may classify each device included in the multi-screen display as having a specific role in the multi-screen display. For example, as illustrated in FIG. 9, the main device 101 may classify the devices such that some devices (a) of a plurality of devices are used as main TVs and some devices (b) of the remaining neighboring devices are used for a channel preview and a remote control (c).

Thereafter, the main device 101 transmits image data to the client devices 102 to 104 in operations 413 and 415, respectively. The multi-screen image may be image data stored in the main device 101 or image data received from an external device or an external network.

First client device 102 and the second client device 104 may output the received portion of the image data in operations 414 and 416, respectively. The image portion output by each of the first client device 102 and the second client device 104 may be split from a main image. The main device 101 may also output a portion of the image data.

Meanwhile, a plurality of client devices included in the multi-screen display may be directly detected by the main device 101. However, when a number of client devices arranged to construct the multi-screen display increases, the newly added client devices may be outside the detectable range of the main device. That is, the client devices may be located within a range in which the NFC module or the various sensors cannot detect the client devices.

In this instance, the first client device 102, which was the first to connect to main device 101, may detect the second client device 104 located outside the detectable range of main device 101. At this time, the main device 101 may indirectly transmit/receive data to/from the second client device 104 through the first client device 102 or directly transmit/receive data to/from the second client device 104 through a communication connection in some cases.

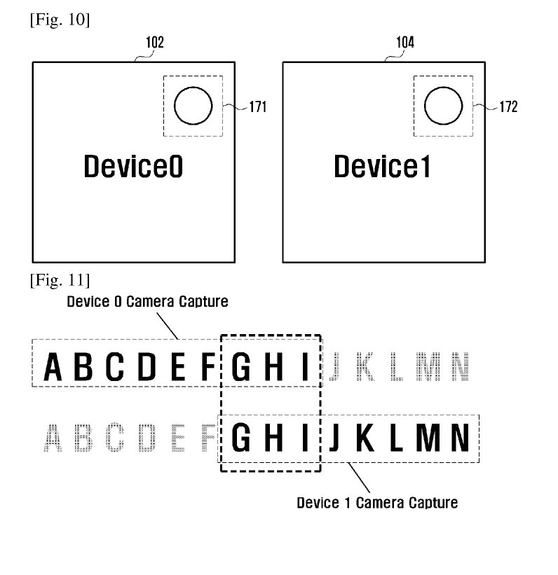

FIG. 10 illustrates an example of the electronic devices constructing the multi-screen display in accordance with aspects of the present disclosure, and FIG. 11 is a working example in which a relative coordinate of the electronic device is determined. Referring to FIG. 10, it is assumed that the neighboring first electronic device 102 and second electronic device 104 include a first camera 171 and a second camera 172, respectively. Furthermore, an image to be obtained through a camera may be located in front of the first camera 171 and the second camera 172.

As illustrated in FIG. 11, captured images corresponding to the image located in front of the first camera 171 and the second camera 172 may be obtained through the first camera 171 and the second camera 172. Relative positions of the first electronic device 102 and the second electronic device 102 may be detected through an analysis of the capture images, and relative coordinates may be configured accordingly. That is, by comparing overlapping areas in the captured images and non-overlapping areas of the captured images, the relative positions of the first electronic device 102 and the second electronic device 102 may be detected.

For example, an image in which letters are sequentially arranged in parallel is prepared in front of the first and second cameras 171 and 172, an image generated by capturing the image through the first camera 171 is an upper image of FIG. 11, and an image generated by capturing the image through the second camera 172 is a lower image of FIG. 11. It is noted, through an analysis of the captured images, that the first electronic device 102 having the first camera 171 is located at a left side of the second electronic device 104 having the second camera 172.

The above-described embodiments of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer.

In addition, an artisan understands and appreciates that a “processor” or “microprocessor” constitute hardware in the claimed invention. The functions and process steps herein may be performed automatically or wholly or partially in response to user command. An activity (including a step) performed automatically is performed in response to executable instruction or device operation without user direct initiation of the activity.

The terms “unit” or “module” referred to herein is to be understood as comprising hardware such as a processor or microprocessor configured for a certain desired functionality, or a non-transitory medium comprising machine executable code.

Although the disclosure herein has been described with reference to particular examples, it is to be understood that these examples are merely illustrative of the principles of the disclosure. It is therefore to be understood that numerous modifications may be made to the examples and that other arrangements may be devised without departing from the spirit and scope of the disclosure as defined by the appended claims. Furthermore, while particular processes are shown in a specific order in the appended drawings, such processes are not limited to any particular order unless such order is expressly set forth herein; rather, processes may be performed in a different order or concurrently and steps may be added or omitted.

1. A method of constructing a multi-screen display using one or more electronic devices, the method comprising:
executing a multi-screen display mode;
registering at least one client device to be included in the multi-screen display;
splitting an image into a plurality of image portions; and
distributing at least one image portion among the at least one client device.

2. The method of claim 1, wherein registering the plurality of client devices comprises a Near Field Communication (NFC) device installed in a main client device and one or more NFC devices installed in one or more other client devices.

3. The method of claim 1, further comprising:
detecting, by a first client device, status information of a second client device; and
transmitting, by the first client device, attribute information and the detected status information of the second client device to a main device.

4. The method of claim 3, wherein detecting the status information of the second client device comprises detecting at least one of a motion of the second client device from the first client device or a position of the second client device relative to the first client device.

5. The method of claim 3, wherein detecting the status information of the second client device comprises:
obtaining a first image through a camera installed in the first client device;
obtaining a second image through a camera installed in the second client device;
comparing and analyzing the first image and the second image; and
determining a position of the second client device relative to the first client device based at least partially on the comparison and analysis.

6. The method of claim 5, wherein comparing and analyzing the first image and the second image comprises comparing overlapping and non-overlapping areas between the first image and the second image.

7. The method of claim 3, wherein detecting the status information of the second client device comprises using at least one of an acceleration sensor, an image sensor, a camera sensor, or an NFC device included in the first client device.

8. The method of claim 3, further comprising splitting the image based on the status information of the second client device received from the first client device.

9. The method of claim 3, wherein the first client device is registered by the main device and the second client device is registered by the first client device.

10. An electronic device supporting a construction of a multi-screen display, the electronic device comprising:
a processor configured to:
receive, using a communication unit, status information and attribute information from a plurality of client devices;
identifying coordinates of each of the plurality of client devices relative to the coordinates of the electronic device using the status information and the attribute information of the plurality of client devices; and
split an image into a plurality of image portions; and
distribute the plurality of image portions among the plurality of client devices using the coordinates of each of the plurality of client devices.

11. The electronic device of claim 10, wherein the processor to further classify each of the plurality of devices included in the multi-screen display as serving a unique purpose in the multi-screen display based at least partially on the coordinates of each of the plurality of client devices.

12. The electronic device of claim 10, wherein the communication unit comprises at least one of:
a Near Field Communication (NFC) device configured to detect a contact of a client device;
a WiFi device configured to transmit data to the client device or received date from the client device;
a Bluetooth device; or
a ZigBee device.

13. The electronic device of claim 10, wherein the electronic device comprises a sensor configured to detect a relative coordinate of the client device, and wherein the sensor includes at least one of an acceleration sensor, an image sensor, a camera sensor, or an infrared sensor.

14. The electronic device of claim 10, wherein the client device includes a first client device and a second client device, wherein the first client device is configured to obtain status information and attribute information of the second client device and transmit the obtained status information and attribute information to the electronic device.

15. The electronic device of claim 14, wherein the first client device and the second client device are configured to obtain front images through cameras and compare the obtained images to identify the coordinates.

16. A non-transitory, computer-readable recording medium storing one or more executable instructions, that when executed by one or more processors, cause the one or more processors to:
receive, using a communication unit, status information and attribute information from a plurality of client devices;
identifying coordinates of each of the plurality of client devices relative to the coordinates of the electronic device using the status information and the attribute information of the plurality of client devices; and
split an image into a plurality of image portions; and
distribute the plurality of image portions among the plurality of client devices using the coordinates of each of the plurality of client devices.

17. The non-transitory, computer-readable recording medium storing one or more executable instructions of claim 16, wherein the one or more executable instructions, when executed by the one or more processors, further cause the one or more processors to classify each of the plurality of devices included in the multi-screen display as serving a unique purpose in the multi-screen display based at least partially on the coordinates of each of the plurality of client devices.

18. The non-transitory, computer-readable recording medium storing one or more executable instructions of claim 16, wherein the communication unit comprises at least one of:
a Near Field Communication (NFC) device configured to detect a contact of a client device;
a WiFi device configured to transmit data to the client device or received date from the client device;
a Bluetooth device; or a ZigBee device.

19. The non-transitory, computer-readable recording medium storing one or more executable instructions of claim 16, wherein the client device includes a first client device and a second client device, wherein the first client device is configured to obtain status information and attribute information of the second client device and transmit the obtained status information and attribute information to the electronic device.

20. The non-transitory, computer-readable recording medium storing one or more executable instructions of claim 19, wherein the first client device and the second client device are configured to obtain front images through cameras and compare the obtained images to identify the coordinates.
